(19) United States
(12) Patent Application Publication
(10) Pub. No.: US 2025/0373066 A1
(43) Pub. Date: Dec. 4, 2025

(54) MOBILE CHARGING UNIT

(71) Applicant: Oshkosh Corporation, Oshkosh, WI (US)

(72) Inventors: Kevin Cecil, Oshkosh, WI (US); Nick Heemskerk, Oshkosh, WI (US); Jared Cline, Oshkosh, WI (US); Allen Tang, Oshkosh, WI (US); Robert Zschoche, Oshkosh, WI (US)

(73) Assignee: Oshkosh Corporation, Oshkosh, WI (US)

(21) Appl. No.: 18/680,809

(22) Filed: May 31, 2024

(51) Int. Cl. H02J 7/14; B60L 53/18; B60L 53/57; B60L 53/67; H02J 1/08; H02J 7/00

(52) U.S. Cl. CPC H02J 7/1423; H02J 1/084; H02J 7/0047; H02J 7/1415; B60L 53/18; B60L 53/57; B60L 53/67

(57) ABSTRACT

A mobile charging unit includes a chassis, a plurality of tractive assemblies, and a charging system. The chassis includes a support surface. The plurality of tractive assemblies are coupled to the chassis. The charging system includes at least one of (a) an on-board power system positioned along the support surface and configured to provide electrical energy or (b) a power input configured to receive power from an external power source, a plurality of chargers configured to electrically couple with at least one ground service equipment to provide electrical energy thereto, and a power distribution unit electrically coupled with the plurality of chargers and the at least one of the on-board power system and the power input. The power distribution unit is configured to provide electrical energy provided by at least one of (i) the on-board power system or (ii) the external power source to the plurality of chargers.

### BACKGROUND

Vehicles and other ground support equipment, such as electric vehicles and electric ground support equipment, must typically navigate to a charger located at a fixed location to re-charge. Navigating to the fixed location can be inconvenient and lead to an increased amount of time spent to re-charge, leading to increased downtime and operational costs.

### SUMMARY

One embodiment relates to a mobile charging unit. The mobile charging unit includes a chassis, a plurality of tractive assemblies, and a charging system. The chassis includes a support surface. The plurality of tractive assemblies are coupled to the chassis. The plurality of tractive assemblies are configured to engage a ground surface. The charging system includes at least one of (a) an on-board power system positioned along the support surface and configured to provide electrical energy or (b) a power input configured to receive power from an external power source, a plurality of chargers configured to electrically couple with at least one ground service equipment to provide electrical energy thereto, and a power distribution unit electrically coupled with the plurality of chargers and the at least one of the on-board power system and the power input. The power distribution unit is configured to provide electrical energy provided by at least one of (i) the on-board power system or (ii) the external power source to the plurality of chargers.

Another embodiment relates to a mobile charging unit. The mobile charging unit includes a chassis, a plurality of tractive assemblies coupled to the chassis, a charging system, and a control system. The chassis includes a support surface. The plurality of tractive assemblies are configured to engage a ground surface. The charging system includes a generator positioned along the support surface and configured to generate electrical energy, a plurality of chargers configured to electrically couple with at least one ground service equipment (GSE) to provide electrical energy thereto, a plurality of charger mounts configured to couple to the support surface of the chassis and support the plurality of chargers, a power input configured to receive power from an external power source, and a power distribution unit electrically coupled with the plurality of chargers, the generator, and the power input. The power distribution unit is configured to provide electrical energy at least one of (i) generated by the generator to the plurality of chargers or (ii) provided by the external power source to the plurality of chargers. The control system is configured to control operation of at least one of the generator, the plurality of chargers, or the power distribution unit. The control system is configured to determine a respective charger of the plurality of chargers is free based on a determination that the GSE is not electrically coupled with the respective charger and transmit a signal indicating that the respective charger is available for use.

Still another embodiment relates to a mobile charging unit. The mobile charging unit includes a chassis, a plurality of tractive assemblies coupled to the chassis, a tow bar, a generator system, a power input, a plurality of charger mounts, a plurality of chargers, a power distribution unit, and a track assembly. The chassis has a first end, an opposing second end, a first side, an opposing second side, and a support surface having a substantially rectangular shape with chamfered corners. The plurality of tractive assemblies are configured to engage a ground surface. The tow bar is pivotably coupled to the first end of the chassis. The tow bar is configured to couple to a vehicle to facilitate repositioning the mobile charging unit. The generator system includes a housing positioned along the support surface and a generator positioned within the housing. The housing has an access panel positioned at the first side of the chassis. The power input is configured to receive power from an external power source. The plurality of charger mounts are coupled to the support surface. The plurality of charger mounts include four charger mounts where one of the four charger mounts is positioned at each of the chamfered corners and a fifth charger mount positioned at the first side of the chassis. The plurality of chargers are configured to electrically couple ground service equipment to provide electrical energy thereto. Each of the plurality of chargers is supported by one of the plurality of charger mounts. The power distribution unit is electrically coupled with the plurality of chargers, the generator, and the power input. The power distribution unit is configured to provide electrical energy at least one of (i) generated by the generator to the plurality of chargers or (ii) provided by the external power source to the plurality of chargers. The track assembly couples the fifth charger mount to the support surface. The track assembly is configured to facilitate selectively repositioning the fifth charger mount and a respective charger of the plurality of chargers supported thereby relative to the support surface. Repositioning the respective charger mount and the respective charger supported thereby facilitates accessing the access panel.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is front right perspective view of a charging cart in a first configuration, according to an exemplary embodiment.

FIG. 2 is a rear left perspective view of the charging cart of FIG. 1, according to an exemplary embodiment.

FIG. 3 is a left side view of the charging cart of FIG. 1, according to an exemplary embodiment.

FIG. 4 is a right side view of the charging cart of FIG. 1, according to an exemplary embodiment.

FIG. 5 is a front view of the charging cart of FIG. 1, according to an exemplary embodiment.

FIG. 6 is a rear view of the charging cart of FIG. 1, according to an exemplary embodiment.

FIG. 7 is a top view of the charging cart of FIG. 1, according to an exemplary embodiment.

FIG. 8 is a perspective view of a floor of the charging cart of FIG. 1, according to an exemplary embodiment.

FIG. 9 is a perspective view of a compartment of the charging cart of FIG. 1, according to an exemplary embodiment.

FIG. 10 is a side view of an onboard power system of the charging cart of FIG. 1, according to an exemplary embodiment.

FIG. 11 is a side view of an interior volume of a housing of the on-board power system of FIG. 10, according to an exemplary embodiment.

FIG. 12 is a front view of a charger of the charging cart of FIG. 1, according to an exemplary embodiment.

FIG. 13 is a front view of a power distribution unit of the charging cart of FIG. 1, according to an exemplary embodiment.

FIG. 14 is a front left perspective view of the charging cart of FIG. 1 in a second configuration, according to an exemplary embodiment.

FIG. 15 is a left side view of the charging cart of FIG. 15, according to an exemplary embodiment.

FIG. 16 is a left side view of the charging cart of FIG. 15, according to an exemplary embodiment.

FIG. 17 is a perspective view of charger mounts coupled with a track assembly of the charging cart of FIG. 15, according to an exemplary embodiment.

FIG. 18 is an exploded perspective view of the charger mounts and the track assembly of FIG. 17, according to an exemplary embodiment.

FIG. 19 is a detailed perspective view of the exploded charger mounts and the track assembly of FIG. 18, according to an exemplary embodiment.

FIG. 20 is a detailed perspective view of the assembled charger mount and track assembly of FIG. 17, according to an exemplary embodiment.

FIG. 21 is a schematic block diagram of the charging cart of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment,

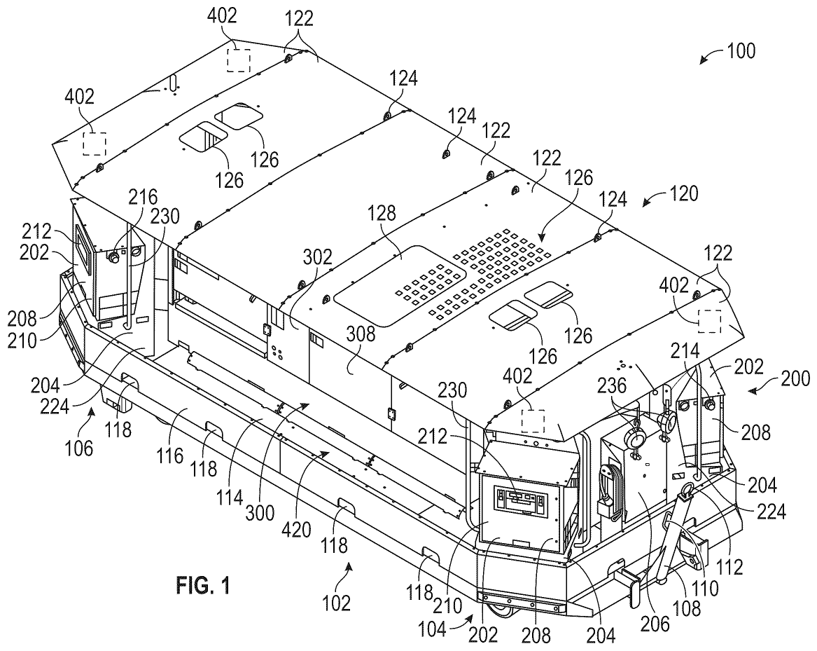

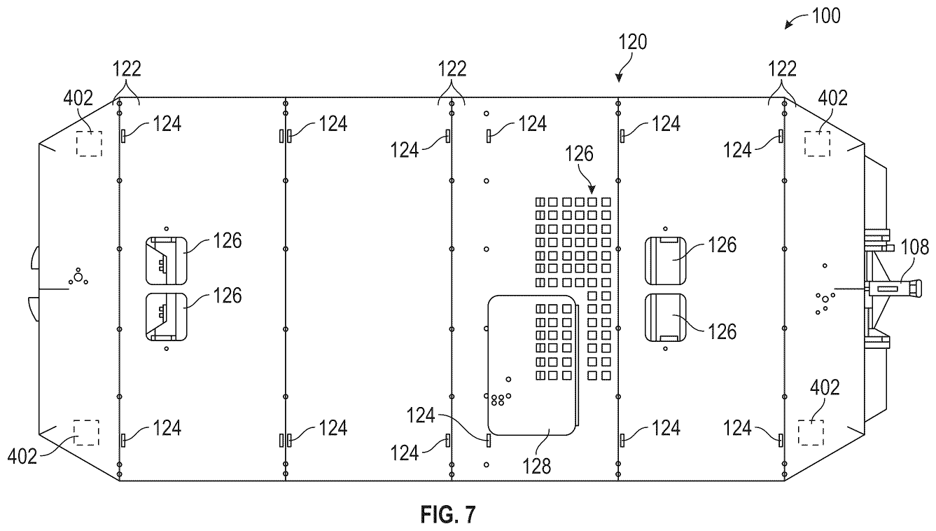

As shown in FIGS. 1-7 and 14-17, a mobile charging unit, shown as charging cart 100, includes a chassis (e.g., a frame assembly, a support deck, etc.), shown as frame 102, a charging assembly, shown as charging system 200, supported by the frame 102, a power assembly (e.g., an on-board power source), shown as on-board power system 300, supported by the frame 102, an Input/Output (“I/O”) system, shown as I/O interfaces 400, and a control system, shown as cart control system 500, coupled to the charging system 200, the on-board power system 300, and the I/O interfaces 400.

According to an exemplary embodiment, the charging cart 100 is a cart or trailer that can be removably coupled to a vehicle to be relocated. The charging cart 100 is configured to provide a mobile charging station (e.g., a charging station configured to be moved between two or more locations) to charge (e.g., electrically charge) or otherwise refuel one or more ground support equipment (“GSE”) (e.g., GSEs 516). In some embodiments, the charging cart 100 is used on a tarmac of an airport to charge the GSE used during various operations conducted on the tarmac. The GSE configured to be charged by the charging cart 100 may include vehicles such as cars, trucks, buses, tractors, etc. The GSE configured to be charged by the charging cart 100 may further include equipment such as belt loaders, pushback tractors, tow-bar-less tractors, bag tugs, cargo loaders, powered dollys, de-icers, and/or another type of ground power equipment (“GPU”) configured to perform one or more operations at the airport. The GSEs are used for one or more operations at the airport including towing one or more other GSEs (e.g., transport the GSEs to a particular location at the airport), transporting people (e.g., employees of the airport to a particular location at the airport, customers from a terminal to an airplane, etc.), towing an airplane, transporting luggage or cargo, loading luggage or cargo, servicing the airplane, de-icing the airplane, providing an emergency response, and/or another operation.

As shown in FIGS. 1-6 and 14-16, the charging cart 100 includes a first tractive assembly (e.g., axles, wheels, tracks, differentials, etc.), shown as front tractive assembly 104, and a second tractive assembly (e.g., axles, wheels, tracks, differentials, etc.), shown as rear tractive assembly 106, coupled to the frame 102. The front tractive assembly 104 and the rear tractive assembly 106 include wheels rotatably coupled with the charging cart 100 and configured to engage with a ground surface to support the frame 102 and the components coupled with the frame 102 (e.g., the charging system 200, the on-board power system 300, the I/O interfaces 400, etc.). The front tractive assembly 104 and the rear tractive assembly 106 space the frame 102 from the ground surface. In some embodiments, the front tractive assembly 104 and/or the rear tractive assembly 106 include wheels or casters rotatably coupled to the frame 102 about a substantially vertical axis to facilitate free movement of the charging cart 100 along the ground surface. In other embodiments, the front tractive assembly 104 and/or the rear tractive assembly 106 are steerable (e.g., using a steering wheel).

In some embodiments, the charging cart 100 includes a suspension system including one or more suspension components (e.g., shocks, dampers, springs, etc.) positioned between the frame 102 and one or more components (e.g., tractive elements, axles, etc.) of the front tractive assembly 104 and/or the rear tractive assembly 106. In some embodiments, the charging cart 100 does not include the suspension system.

As shown in FIGS. 1, 3-5, and 14-16, the charging cart 100 includes a mechanical linkage (e.g., tube, bar, coupler, etc.), shown as tow bar 108. A first end of the tow bar 108 is coupled to a front end the frame 102. The tow bar 108 is pivotably coupled to the frame 102 (e.g., by a hinge, by a pin about which the tow bar 108 can pivot, etc.) and pivotable relative to the frame 102 between a disengaged position and an engaged position. The tow bar 108 includes a handle 110 configured to facilitate pivoting the tow bar 108 between the disengaged position and the engaged position. The tow bar 108 includes an engagement feature, shown as coupler 112, positioned at a second end (opposite the first end) of the tow bar 108 that is configured to selectively engage with a vehicle (e.g., a car, a truck, a tractor, the GSE, etc.) to facilitate towing the charging cart 100. The coupler 112 includes an aperture configured to receive a pin or a hook to couple the tow bar 108 (and the charging cart 100) to the towing vehicle or equipment. In some embodiments, the coupler 112 is otherwise suitably structured (e.g., shaped) to couple the towing vehicle or equipment with the charging cart 100.

When the tow bar 108 is in the engaged position and engaged with the towing vehicle or equipment, and when the towing vehicle or equipment is driven (e.g., by drive motors), the tow bar 108 pulls the charging cart 100 with the towing vehicle or equipment. In this manner, responsive to the towing vehicle or equipment being driven, the tow bar 108 exerts a force on the charging cart 100 such that the charging cart 100 is driven at the same speed, in the same direction, and is maintained at a fixed distance (e.g., the fixed distance being a length of the tow bar 108) from the towing vehicle or equipment. In some embodiments, when the towing vehicle or equipment turns, the towing vehicle or equipment pivots relative to the tow bar 107 and exerts a force on the charging cart 100 to pull the charging cart 100 in the direction of the towing vehicle or equipment.

According to an exemplary embodiment, the tow bar 108 is operatively coupled with a brake system of the charging cart 100. The brake system may include one or more braking components (e.g., disc brakes, drum brakes, in-board brakes, axle brakes, etc.) positioned to facilitate selectively braking one or more components of the front tractive assembly 104 (e.g., the front axle, the front tractive elements, etc.) and/or one or more components of the rear tractive assembly 106 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. The tow bar 108 may be operatively coupled with the brake system of the charging cart 100 such that, in the disengaged position shown in FIGS. 1, 3-5, and 14-16, the braking system brakes one or more components of the front tractive assembly 104 and/or the rear tractive assembly 106 to facilitate braking or otherwise stopping the charging cart 100. In some embodiments, the tow bar 108 is biased (e.g., spring biased) to the disengaged position such that, when the tow bar 108 is not engaged with the towing vehicle or equipment, the braking system brakes the charging cart 100 and inhibits movement of the charging cart 100 along the ground surface. In some embodiments, in the disengaged position, the coupler 112 of the tow bar 108 is positioned at a height that is higher from the ground surface than a height of the element (e.g., the hook) of the towing vehicle or equipment to which the coupler 112 is configured to couple to.

As shown in FIGS. 1-6, 8, and 14-16, the frame 102 includes a support surface, shown as floor 114, and a railing, shown as guard 116, positioned along the periphery of the floor 114. The floor 114 provides a support surface extending within a substantially horizontal plane (e.g., parallel to the ground surface). The floor 114 defines a generally rectangular shape and has chamfered corners. In some embodiments, the corners of the floor 114 are not chamfered. In some embodiments, the floor 114 defines another shape (e.g., square, ovular, circular, hexagonal, etc.). As shown in FIGS. 1-6, 8, and 14-16, the floor 114 is configured to support one or more components or pieces of equipment of the charging cart 100 (e.g., the charging system 200, the on-board power system 300, the I/O interfaces 400, etc.) disposed thereon.

As shown in FIGS. 1-6, 8, and 14-16, the guard 116 extends substantially perpendicular to and upward from the floor 114 along a peripheral edge (e.g., an outer peripheral edge) thereof. The guard 116 includes one or more straight or bent sections. By way of example, the guard 116 may include first sections along a front edge and a rear edge of the floor 114, second sections along the chamfered corners of the floor 114, and third sections along the left and right edges of the floor 114. In some embodiments, the one or more sections of the guard 116 are coupled (e.g., removably coupled) with the floor 114. In other embodiments, the one or more sections of the guard 116 are integrally formed with the floor 114 (e.g., as a single unitary body, welded thereto, etc.). As shown in FIGS. 1-6, 8, and 14-16, the guard 116 is configured as a barrier to protect at least a portion of the one or more components or pieces of equipment (e.g., the charging system 200, the on-board power system 300, the I/O interfaces 400, etc.) disposed on the floor 114 (e.g., from scrapes, abrasions, and other damage). The guard 116 may inhibit the one or more components or pieces of equipment disposed on the floor 114 from falling off of the charging cart 100 as the charging cart 100 is towed or otherwise repositioned.

As shown in FIGS. 1-6, 8, and 14-16, the guard 116 includes or defines a plurality of apertures (e.g., through-holes, passageways, drains, etc.), shown as openings 118, variously positioned along an edge of the guard 116 that interfaces with the floor 114. The openings 118 permit fluid (e.g., rainwater, snow, melted snow, etc.) collected on the floor 114 to pass therethrough, and thereby permit draining the fluid on the floor 114 off of the charging cart 100. The openings 118 limit buildup of fluid and flooding on the floor 114 to limit or mitigate fluid damage to the one or more components or pieces of equipment (e.g., the charging system 200, the on-board power system 300, the I/O interfaces 400, etc.) disposed on the floor 114. The openings 118 additionally provide a space for a user to step (e.g., space for a user's foot to extend through the guard 116) onto the floor 114 to help the user ingress onto or egress from the charging cart 100 (e.g., to service, replace, test, etc. one or more components of the charging cart 100).

As shown in FIGS. 1-7, 15, and 16, the charging cart 100 includes a cover, shown as roof 120. The roof 120 is configured to provide a cover for weather resistance, falling objects, etc. for the one or more components of the charging cart 100 (e.g., the charging system 200, the on-board power system 300, etc.). The roof 120 may be removably coupled to the charging cart 100 to facilitate installation, maintenance, and/or replacement of the one or more components of the charging cart 100 (e.g., the charging system 200, the on-board power system 300, etc.). The roof 120 includes a plurality of panels, shown as roof panels 122, configured to be coupled together to form a single roof structure. In some embodiments, the roof panels 122 are fastened together using one or more fasteners (e.g., bolts, screws, rivets, etc.). Additionally or alternatively, in some embodiments, the roof panels 122 are welded, adhered (e.g., using an adhesive), or otherwise coupled together. By way of example, portions of the roof panels 122 capable of withstanding welds (e.g., capable of not breaking or deforming) may be welded together, and portions of the roof panels 122 not capable of withstanding welds (e.g., thinner portions of the roof panels 122, portions of the roof panels 122 that could break, deform, or otherwise fail if they were to be welded) may be adhered together or otherwise bonded together. The roof 120 being made from multiple roof panels 122 makes shipping and instillation of the roof 120 easier. In some embodiments, the roof 120 is formed as a single unitary body (e.g., without multiple roof panels 122). In some embodiments, the charging cart 100 does not include the roof 120.

As shown in FIGS. 1, 2, 5-7, and 15, the roof 120 includes a plurality of attachment points (e.g., eyelets, loops, etc.), shown as engagement interfaces 124, extending from and variously positioned about a top surface of the roof 120 (e.g., a surface of the roof 120 facing upwards when installed). The engagement interfaces 124 include an aperture configured to receive a portion of an effector (e.g., a hook, a rope, of a lifting device such as a crane, etc.) to facilitate installing the roof 120 and the roof panels 122 onto the charging cart 100. In some embodiments, the roof 120 does not include the engagement interfaces 124.

As shown in FIGS. 1, 2, and 7, the roof 120 includes or defines a plurality of apertures, shown as openings 126, and a door (e.g., lid, cover, etc.), shown as roof access panel 128. The openings 126 are variously positioned about the roof 120 and are configured to permit airflow therethrough to facilitate cooling of and heat dissipation from the one or more components of the charging cart 100 (e.g., the charging system 200, the on-board power system 300, etc.) positioned below the roof 120. In some embodiments, the roof 120 does not include the openings 126. As shown in FIGS. 1, 2, and 7, the roof access panel 128 is positioned along the roof 120 and is movable between a closed position and an open position to provide selective access to the one or more components of the charging cart 100 (e.g., the charging system 200, the on-board power system 300, etc.) positioned below the roof 120. Access to the one or more components of the charging cart 100 using the roof access panel 128 facilitates a user replacing, repairing, testing, cleaning, or refueling one or more components of the charging cart 100 positioned beneath the roof 120.

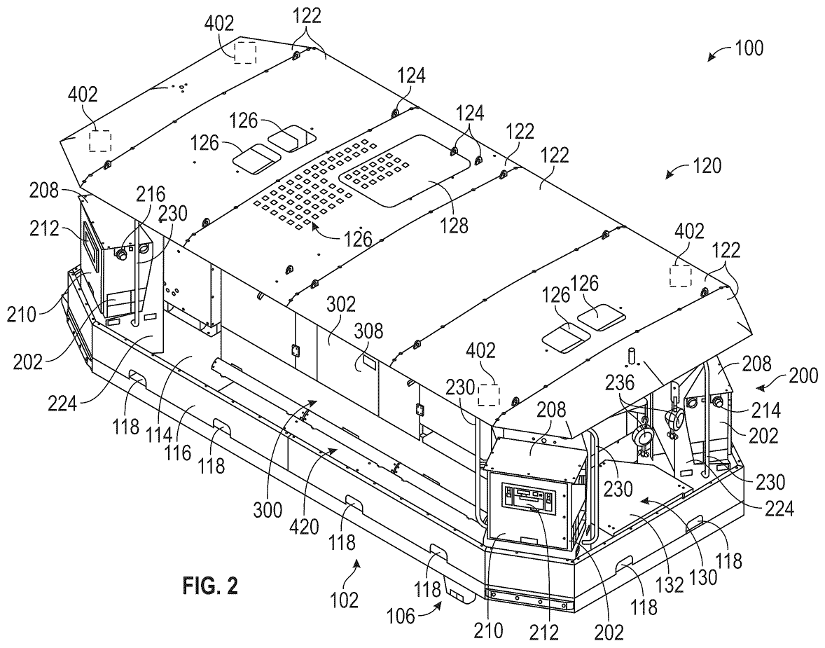

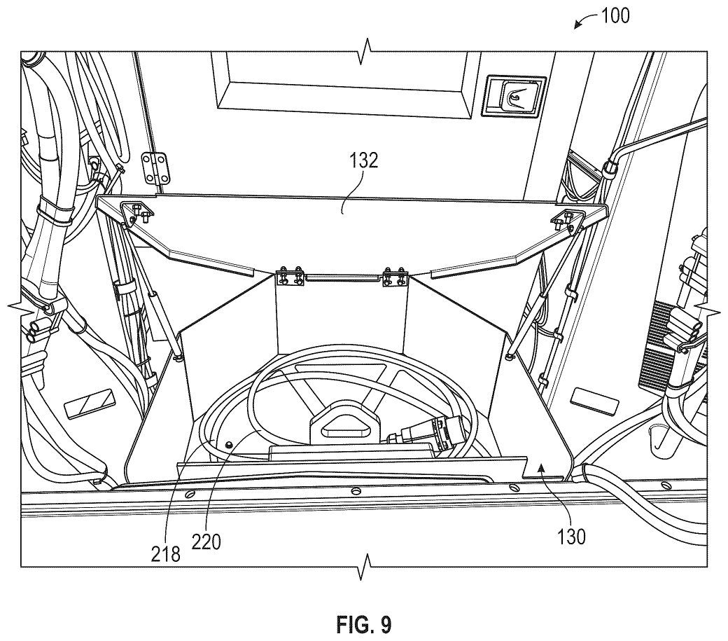

As shown in FIGS. 2 and 9, the charging cart 100 includes a storage unit, shown as compartment 130, positioned at or proximate a rear end thereof and disposed along the floor 114. In other embodiments, the compartment 130 is otherwise positioned. As shown in FIGS. 2 and 9, the compartment 130 includes a door (e.g., panel, cover, etc.), shown as lid 132, selectively movable between a closed position and an open position to provide selective access to an interior volume defined by the compartment 130. The compartment 130 is configured to store one or more pieces of equipment or components of the charging cart 100 when they are not in use. By way of example, the compartment 130 may store cables (e.g., the first battery cable 218, the second battery cable 220), tools, replacement parts, or one or more other pieces of equipment.

As shown in FIGS. 1-6 and 12-16, the charging system 200 includes one or more charging units, shown as chargers 202, one or more charger supports (e.g., charger stands, support racks, etc.), shown as charger mounts 204, configured to support the chargers 202, and a power transfer panel, shown as power distribution unit (“PDU”) 206, electrically coupled with the chargers 202 and the on-board power system 300. The charger 202 is configured to receive electrical energy (e.g., electrical energy generated by the on-board power system 300, electrical energy provided by an external power source, electrical energy distributed by the PDU 206, etc.) and supply the electrical energy to the GSE to provide power thereto (e.g., to charge an energy storage system or battery thereof).

As shown in FIGS. 1-6, 12, and 14-16, the charger 202 has a housing, shown as body 208, including a panel, shown as front panel 210, a charger interface, shown as user interface 212, a first charging interface, shown as first output 214, and a second charging interface, shown as second output 216. In some embodiments, the front panel 210 is removably coupled to the body 208 to provide access to the components housed within the body 208. As shown in FIGS. 1-6, 12, and 14-16, the user interface 212 includes a display and an operator input. The display may be configured to display a graphical user interface, an image, an icon, or still other information. In some embodiments, the display includes a graphical user interface configured to provide information relating to an operation of the charger 202. By way of example, the display of the user interface 212 may display battery level (e.g., a level of the battery being charged by the charger 202), a charger performance/status (e.g., whether the charger 202 is providing or receiving electrical energy), warning lights (e.g., indicative of improper or dangerous operations), or other information relating to the charger 202, the PDU 206, the on-board power system 300, and/or the charging cart 100.

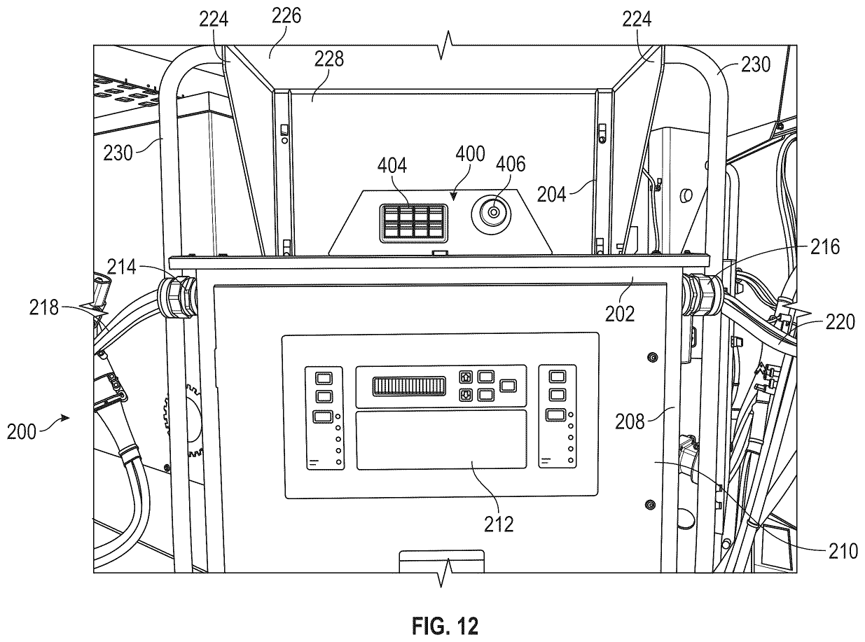

The operator input of the user interface 212 may be used by an operator to provide commands to the components of the charger 202, the PDU 206, the on-board power system 300, and/or still other components or systems of the charging cart 100. As shown in FIG. 12, the operator input includes various inputs to provide the operator with control capabilities over the charger 202. The operator input may include one or more buttons, knobs, touchscreens, switches, levers, joysticks, pedals, or handles. By way of example, the operator can press a button and/or otherwise interface with the operator input to command the charger 202 to start or stop charging, change a rate of charging, equalize with the battery electrically coupled thereto, navigate a charger menu, etc.

As shown in FIGS. 1-6, 12, and 14-16, the first output 214 is configured to receive or engage with a cable (e.g., a wire), shown as first battery cable 218, and the second output 216 configured to receive a cable (e.g., a wire), shown as second battery cable 220. The first battery cable 218 and the second battery cable 220 are each configured to couple with the GSE to facilitate electrically coupling each charger 202 with two GSEs. By way of example, the charger 202 may provide electrical energy to a first GSE via the first battery cable 218 and may provide electrical energy to a second GSE via the second battery cable 220. The charger 202 is configured to charge the first GSE independent from charging the second GSE. In this manner, a single charger 202 is capable of charging two different GSEs at the same time. By way of example, the charger 202 may charge the first GSE at a charging rate, voltage, amperage, power, etc. for a certain period of time that is different than a charging rate voltage, amperage, power, time used to charge the second GSE. In some embodiments, the charger 202 is configured to output (e.g., supply through the first battery cable 218 and the second battery cable 220) electrical energy at a voltage between about 24V (e.g., about 23V, about 25V, etc.) and about 96V (e.g., about 95V, about 97V, etc.). In some embodiments, the charger 202 is configured to output electrical energy at a voltage greater than 96V (e.g., 120V, 210V, 220V, 400V, etc.). In some embodiments, the charger 202 includes more or fewer than two outputs to facilitate charging only one GSE at a time or more than two GSEs at a time.

As shown in FIGS. 1-6, 12, and 14-17, the charger mount 204 includes a support surface or pedestal 222, sidewalls 224, a top portion 226, and a back wall 228. The sidewalls 224 extend within a substantially vertical plane perpendicular to the pedestal 222 and are spaced apart by the pedestal 222 (e.g., the pedestal 222 is positioned between the sidewalls 224). The back wall 228 extends within a substantially vertical plane perpendicular to the pedestal 222 and the sidewalls 224. The top portion 226 extends between the sidewalls 224 and is positioned proximate a top edge of the sidewalls 224 and the back wall 228. The pedestal 222, the sidewalls 224, the top portion 226, and the back wall 228 of the charger mount 204 collectively define a space to receive and support the charger 202.

As shown in FIGS. 1-6, 12, and 14-16, the pedestal 222 is configured to engage with and support a bottom surface of the body 208, the sidewalls 224 are configured engage with and support opposing sides of the body 208 to inhibit side-to-side translation (e.g., lateral translation and/or longitudinal translation) of the charger 202 relative to the charger mount 204, and the back wall 228 is configured to engage with and support a back surface of the charger 202 to inhibit rearward translation of the charger 202 relative to the charger mount 204. The charger 202 may be coupled to the charger mount 204 by one or more fasteners (e.g., bolts, screws, brackets, clamps, etc.) and/or fastening methods (e.g., welds, adhesives, friction, etc.). As shown in FIGS. 1-6 and 14-16, the pedestal 222 is configured (e.g., positioned, sized, shaped, etc.) to vertically space the charger 202 from the floor 114 to position the charger 202 (e.g., the user interface 212 of the charger 202) at a height where (i) the operator can adequately reach the user interface 212 while standing on the ground surface and (ii) the bottom of the charger 202 substantially aligns with the top edge of the guard 116. In some embodiments, the charger 202 is coupled to the back wall 228 of the charger mount 204 (e.g., in addition to or as an alternative to being supported by the pedestal 222). As shown in FIGS. 1-6 and 14-16, the sidewalls 224 and the pedestals 222 of the charger mount 204 extend from the floor 114 to couple the charger mount 204 to the charging cart 100. The charger mount 204 is removably coupled to the floor 114 using one or more fasteners. In other embodiments, the charger mount 204 is fixedly coupled (e.g., welded) to the floor 114.

As shown in FIGS. 1-6, 12, and 14-17, the charger mount 204 includes a pair of grips, shown as handles 230, extending along an outer surface of the sidewalls 224 in a direction substantially vertically between the pedestal 222 and the top portion 226. The handles 230 provide an area for a user to grip (e.g., to help the user enter, climb onto, or egress from the charging cart 100).

As shown in FIGS. 1-6 and 14-17, the charger mount 204 includes a first cable support arm, shown as first arm 232, and a second cable support arm, shown as second arm 234, each pivotably coupled to interfaces (e.g., brackets, etc.) of the top portion 226 of the charger mount 204. The first arm 232 and the second arm 234 are pivotable about a substantially vertical axis at a first end or proximal end thereof between a stowed position and an extended position. In some embodiments, charging cart 100 includes a retainer (e.g., a latch, a stop, a clamp, etc.) configured to retain the first arm 232 and the second arm 234 in the stowed position to limit movement thereof during transportation of the charging cart 100. The first arm 232 and the second arm 234 are manually and/or automatically (e.g., electrically, hydraulically, pneumatically, etc.) repositionable between the stowed position and the extended position.

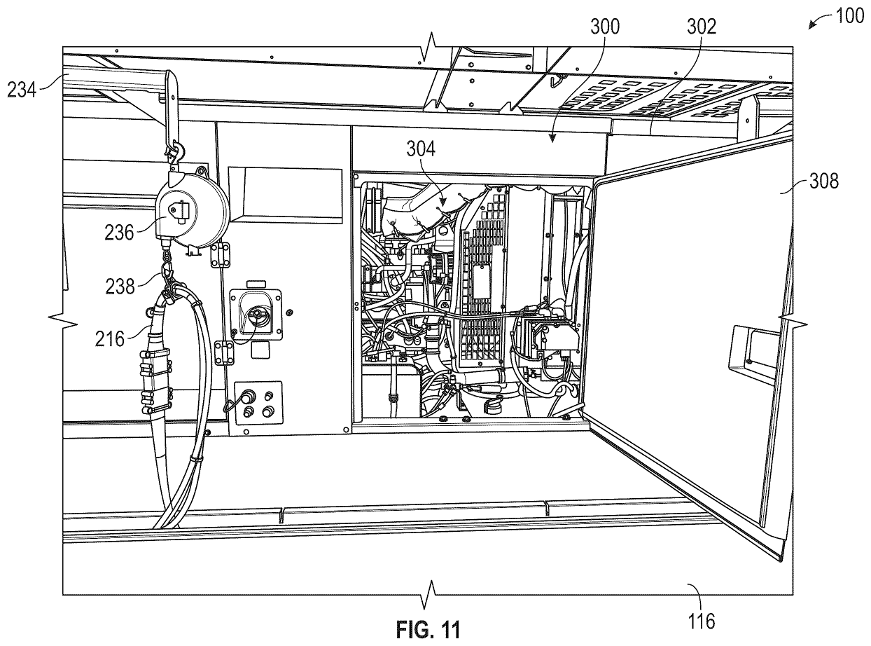

As shown in FIGS. 1-6, 11, and 13-17 the first arm 232 and the second arm 234 each include a cable spool, shown as reel 236, coupled to a second end or distal end thereof (e.g., the first end being opposite the second end). The first arm 232 and the second arm 234 are repositionable between the stowed position and the extended position to facilitate repositioning the reel 236 relative to the charger 202. As shown in FIGS. 11, 13, and 15, the reel 236 includes a line wound within the reel 236 (e.g., around a spool within the reel 236). A free end of the line is coupled to an interfacing element (e.g., hook, clip, etc.), shown as coupler 238. The coupler 238 of each reel 236 is configured to selectively couple with the first battery cable 218 or the second battery cable 220, respectively. In some embodiments, the reel 236 includes a retraction mechanism (e.g., a spring loaded mechanism) configured to wind and unwind the line from the reel 236 to change the length of the line let out from the reel 236. In such embodiments, a user can wind or unwind the line such that a desired length of the first battery cable 218 and the second battery cable 220 can be used to reach the GSE (e.g., to be charged thereby). The reel 236 facilitates compact storage of the first battery cable 218 and the second battery cable 220 and helps to prevent the first battery cable 218 and the second battery cable 220 from being left lying on the ground when not in use, thereby limiting tripping and electrical hazards. In some embodiments, the first arm 232 and the second arm 234 do not include the reel 236, and the first battery cable 218 and the second battery cable 220 are otherwise stored on the charging cart 100.

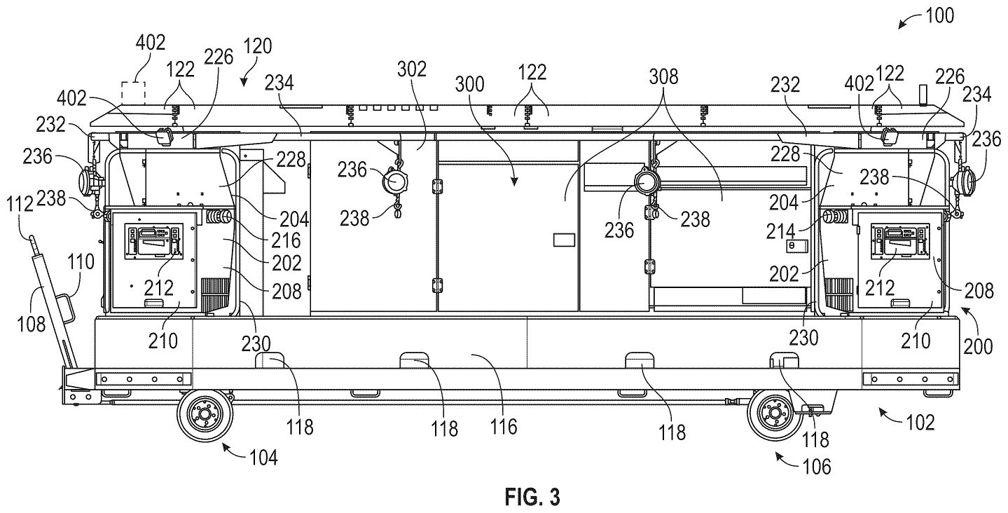

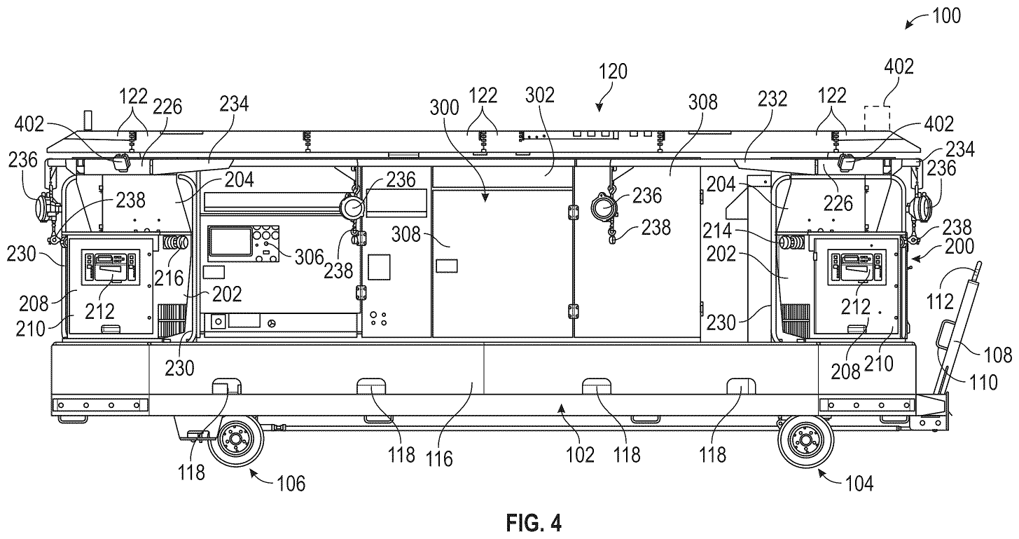

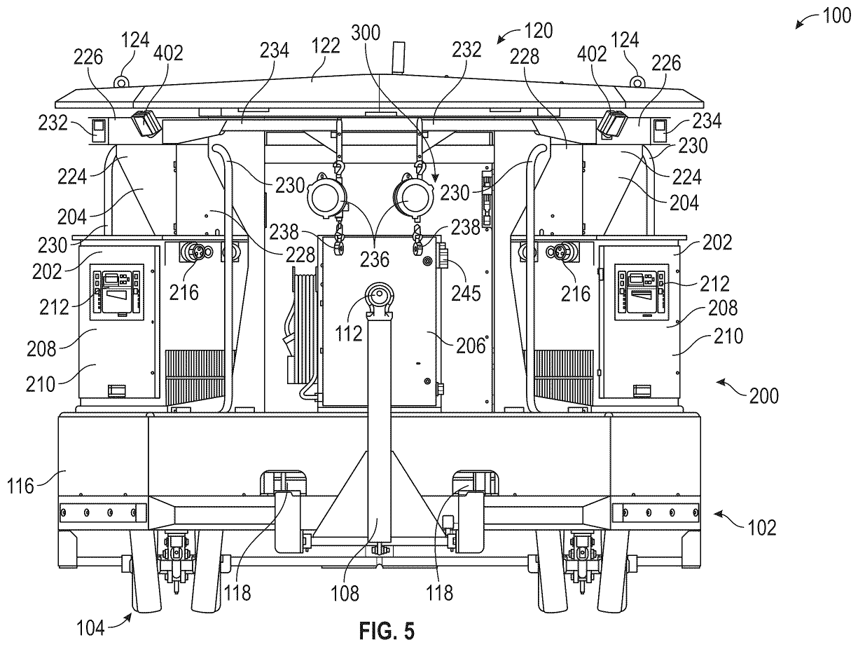

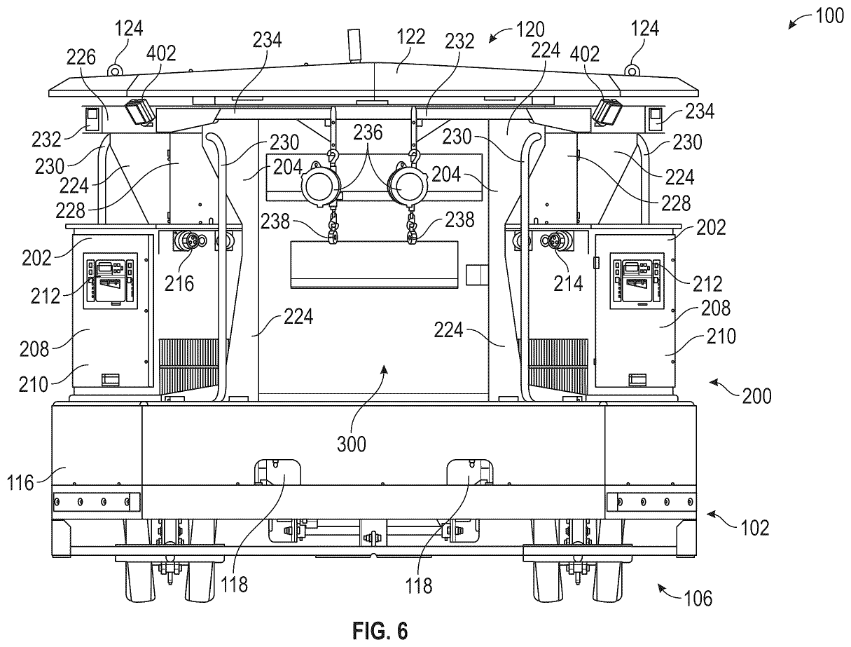

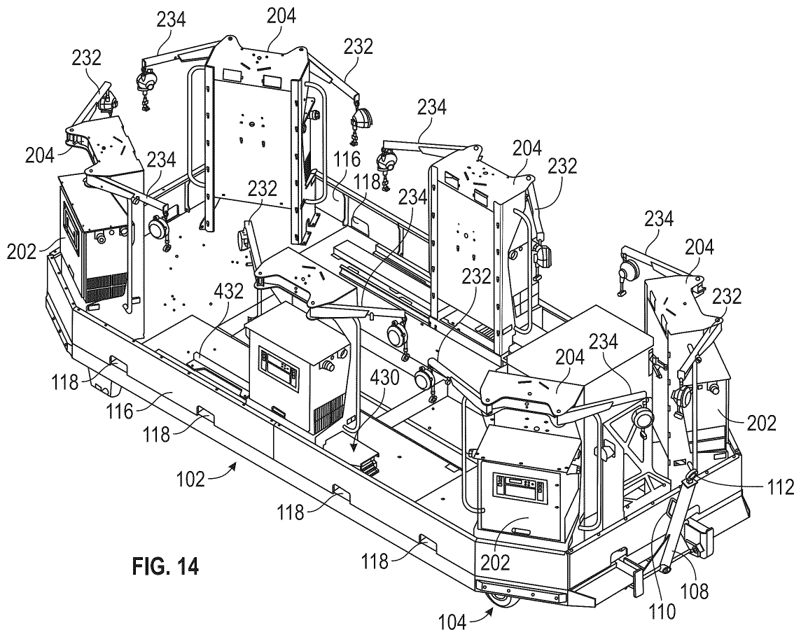

As shown in FIGS. 3-6 and 14-17, a length of the first arm 232 and the second arm 234 are suitably sized such that when the charger mounts 204 are installed on the charging cart 100, the first arm 232 (e.g., the second end of the first arm 232) does not contact the second arm 234 (e.g., the second end of the second arm 234) of an adjacent charger mount 204. According to an exemplary embodiment, the length of the first arm 232 and the second arm 234 vary depending on (i) the number of charger mounts 204 installed on the charging cart 100 and (ii) the positioning of the charger mounts 204 installed on the charging cart 100 relative to each other. In some embodiments, as shown in FIGS. 3-6, four charger mounts 204 are installed on the charging cart 100 (e.g., one at each of the four corners). In such embodiments, the first arms 232 and the second arms 234 extending in a longitudinal direction (e.g., in a direction between a front end and a rear end of the charging cart 100 when in the stowed position) are longer than the first arms 232 and the second arms 234 extending in a lateral direction (e.g., in a direction between a left side and a right side of the charging cart 100 when in the stowed position) (see, e.g., the second arm 234 of the left-most charger mount 204 and the first arm 232 of the right-most charger mount 204 in FIGS. 3 and 4 are longer than the second arm 234 of the left-most charger mount 204 and the first arm 232 of the right-most charger mount 204 in FIGS. 5 and 6). The longer length of the particular first arms 232 and second arms 234 facilitate increasing a range that the first battery cable 218 and the second battery cable 220 respectively coupled thereto can reach. In some embodiments, as shown in FIGS. 14-17, six charger mounts 204 are installed on the charging cart 100 (e.g., one at each of the four corners and one along each of the left and right sides). In such embodiments, the first arms 232 and the second arms 234 of each charger mount 204 are substantially the same length (e.g., to make room for the two additional charger mounts along the left and right sides). In some embodiments, the first arm 232 or the second arm 234 of a particular charger mount 204 overlaps with the second arm 234 or the first arm 232 of an adjacent charger mount 204, respectively.

As shown in FIGS. 1 and 5, the PDU 206 is positioned at or proximate a front end of the charging cart 100 (i.e., opposite the compartment 130). In some embodiments, the PDU 206 is spaced from (e.g., raised off of) the floor 114 (e.g., by a mount) such that liquid along the floor 114 does not contact or damage the PDU 206. In some embodiments, the PDU 206 is coupled to a housing (e.g., the housing 302) of the on-board power system 300. In other embodiments, the PDU 206 is otherwise positioned. As shown in FIGS. 1, 5, and 13, the PDU 206 includes a selection interface, shown as user interface 240, an emergency stop button, shown as emergency stop 242, and one or more cables, shown as power cables 244, electrically coupled via one or more power terminals, shown as power inputs 245, of the PDU 206. The PDU 206 is configured to receive power from one or more sources (e.g., the on-board power system 300, an external power source, each of the on-board power system 300 and the external power source at the same time, etc.) via the power inputs 245 electrically coupled with the power cables 244 and allocate the received power to one or more systems of the charging cart 100 (e.g., the chargers 202, the I/O interfaces 400, other electrical systems of the charging cart 100, etc.) via one or more output cables or wiring of the power cables 244. In some embodiments, the PDU 206 includes one or more components (e.g., inverters, converters, bus bars, etc.) to facilitate distributing the received power, converting the received electrical energy (e.g., between direct current (“DC”) and alternating current (“AC”), from AC to DC, from DC to AC, etc.), adjusting a voltage level (e.g., stepping down the voltage, from 96V to 24V, from 24V to 12V, from 12V to 5V, for example, etc.), and/or otherwise controlling the received power.

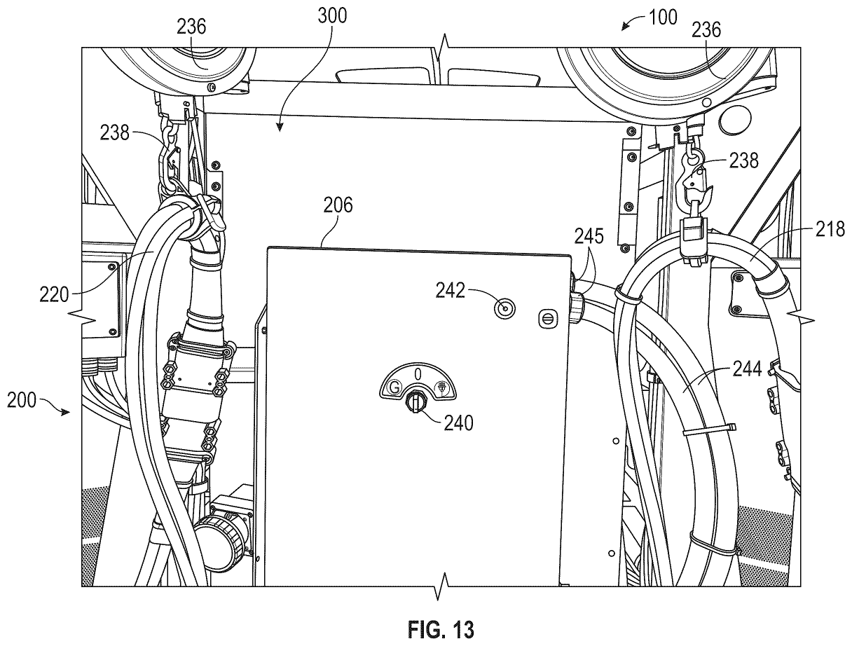

As shown in FIG. 13, the user interface 240 includes a knob. In some embodiments, the user interface 240 includes one or more additional or alternative buttons, knobs, touchscreens, switches, levers, joysticks, pedals, or handles. The user interface 240 may be used by an operator to provide commands to the PDU 206. By way of example, the operator can interface with the user interface 240 to command the PDU 206 to toggle between off, receiving power from either the on-board power system 300, or receiving power from an external power source (e.g., a power grid, a generator, an external battery, a mains power supply of the airport, etc.). As shown in FIG. 13, the user interface 240 includes a toggle to stop the PDU 206 from receiving power from any power source and to stop the PDU 206 from distributing the power. The emergency stop 242 may be used by the operator to manually override one or more operations of the PDU 206, the charging cart 100, and/or any one or more components included therein (e.g., isolate components, shut the charging cart 100 down, etc.).

As shown in FIGS. 1-6, 8-13, 15, and 16, the on-board power system 300 includes a housing 302 defining an interior volume, an electrical energy source (e.g., a power generation unit), shown as power generator 304, disposed within the interior volume of the housing 302, and a control panel, shown as user interface 306, along an exterior surface of the housing 302. One or more of the sidewalls of the housing 302 are or include a door (e.g., lid, cover, etc.), shown as access panel 308. The housing 302 includes two access panels 308, one on each side thereof. In some embodiments, the housing 302 includes more or fewer than one access panel 308 on each side thereof. According to the exemplary embodiment shown in FIG. 11, the access panels 308 are pivotable between a closed position and an open position to provide selective access to the interior volume of the housing 302, the power generator 304 within the interior volume, the user interface 306, and other components housed within the housing 302. In other embodiments, the access panels 308 are removable, rather than pivotable. In still other embodiments, the access panels 308 are rollable up and down. Access to the interior volume of the housing 302 using one or more of the access panels 308 facilitates a user replacing, repairing, testing, cleaning, or refueling the power generator 304 and/or the other components housed within the housing 302. Access to the user interface 306 using one of the access panels 308 facilitates a user controlling and monitoring operation of the on-board power system 300.

In some embodiments, the power generator 304 includes an internal combustion engine (e.g., a spark-ignition internal combustion engine, a compression-ignition internal combustion engine, etc.) that may use any suitable fuel type (e.g., diesel, ethanol, gasoline, natural gas, propane, etc.) and an electromagnetic device (e.g., an alternator, an electric motor/generator, etc.) driven by the internal combustion engine to generate electricity. In some embodiments, the power generator 304 includes an electric motor to generate electricity. In some embodiments, the power generator 304 includes a fuel cell that produces electricity from hydrogen (e.g., performs an electrochemical reaction to generate electricity). In some embodiments, the power generator 304 is a hybrid power generation unit whereby the power generator 304 includes an internal combustion engine, an electric motor, and/or a fuel cell. In some embodiments, the on-board power system 300 is mobile ready such that the power generator 304 and the on-board power system 300 are capable of operating during movement thereof (e.g., acceleration, braking, and turning of the charging cart 100 and the vehicle towing the charging cart 100). In some embodiments, the on-board power system 300, in addition to or in place of the power generator 304, includes a battery pack or bank and/or solar panels (e.g., on the roof 120).

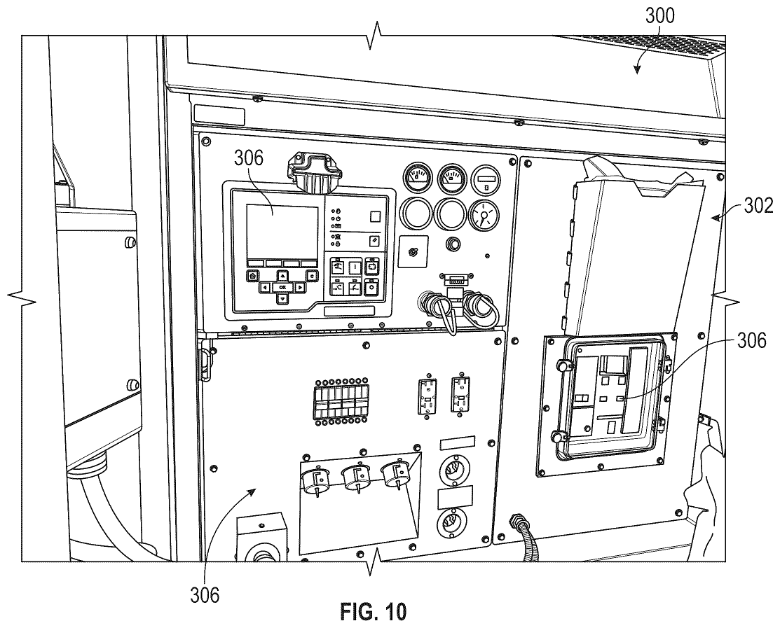

As shown in FIG. 10, the user interface 306 includes a display and an operator input. The display may be configured to display a graphical user interface, an image, an icon, or still other information. In some embodiments, the display includes a graphical user interface configured to provide information relating to an operation of the on-board power system 300. By way of example, the display of the user interface 306 may display energy level (e.g., a level of combustible fuel in the on-board power system 300, a level of a battery of the power generator 304, a level of hydrogen, etc.), a generator performance/status (e.g., whether the on-board power system 300 is providing or receiving electrical energy, a power output of the on-board power system 300, etc.), warning lights (e.g., indicative of improper or dangerous operations, faults, etc.), or other information relating to the on-board power system 300, the chargers 202, the PDU 206, and/or the charging cart 100.

The operator input of the user interface 306 may be used by an operator to provide commands to the components of the on-board power system 300 (e.g., the power generator 304) and/or still other components or systems of the charging cart 100. As shown in FIG. 10, the operator input includes various buttons to provide the operator with control capabilities over the on-board power system 300. The operator input may include one or more additional buttons, knobs, touchscreens, switches, levers, joysticks, pedals, or handles. By way of example, the operator can press a button and/or otherwise interface with the operator input to command the on-board power system 300 to start or stop energy generation, navigate a charger menu, etc.

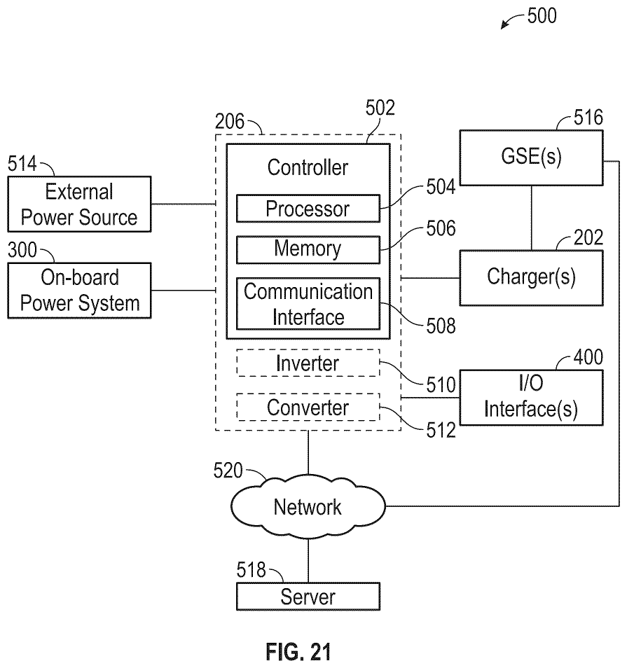

Referring to FIG. 21, the charging cart 100 includes one or more I/O interfaces 400 used to monitor or control one or more aspects of the operation of the charging cart 100 and the components included therein (e.g., the charging system 200, the on-board power system 300, etc.). In some embodiments, the I/O interfaces 400 include a joystick, buttons, switches, knobs, levers, etc. In some embodiments, the I/O interfaces 400 include at least one of a screen, a monitor, a visual display device, a touchscreen display, a television, a video display, a light emitting diode (“LED”) display, a mobile device, a kiosk, a digital terminal, a mobile computing device, a desktop computer, a smartphone, a tablet, a smart watch, a smart sensor, and/or any other device that can facilitate providing, receiving, displaying and/or otherwise interacting with content (e.g., webpages, mobile applications, etc.). For example, the I/O interfaces 400 may include displays that include a resistive touchscreen that can receive user input via interactions (e.g., touches) with the touchscreen. In some embodiments, the I/O interfaces 400 receive inputs to control operation of the charging cart 100 and the components included therein (e.g., the charging system 200, the on-board power system 300, etc.). For example, interfacing with the I/O interfaces 400 may cause various control signals to be transmitted to the on-board power system 300 and the PDU 206 that causes the PDU 206 to distribution and convert electrical energy generated by the on-board power system 300 to one or more of the chargers 202, which then transfer the electrical energy to a GSE coupled thereto to charge the GSE.

As shown in FIGS. 1-7, 15, and 16, the I/O interfaces 400 include a plurality of lights (e.g., charger mount lights, warning lights, headlights, tail lights, etc.), shown as lights 402, variously positioned about the charging cart 100 (e.g., disposed about the roof 120, coupled to the top portion 226 of the charger mounts 204, etc.). The lights 402 may be configured to emit lights in various patterns, with various colors, at various frequencies, and/or with varying intensities or brightness. By way of example, the lights 402 may emit pulsing lights, strobing lights, constant lights (e.g., spotlight), colored lights (e.g., amber, red, white, blue, yellow, etc.), etc. The lights 402 may provide flashing lights or controlled to flash such that, when flashing, provide an indication of an operation of the charging cart 100 (e.g., that the charging cart 100 is deployed for charging purposes, such as to charge one or more GSEs, etc.). In some embodiments, the lights 402 are indicative of a free charger 202 (e.g., a first battery cable 218 or a second battery cable 220 thereof that is not in use). In some embodiments, one or more of the lights 402 emit a constant, bright light to illuminate a scene (e.g., the area surrounding the charging cart 100, the GSE, etc.) so operators, employees, etc. may be able to see an otherwise dark area (e.g., illuminate where to couple the first battery cable 218 or the second battery cable 220 to a GSE, illuminate where to park the charging cart 100 and/or the GSE to be charged), for example. In some embodiments, one or more lights 402 operate in coordination with each other (e.g., to cooperatively emit a pattern, to cooperatively illuminate the scene, etc.)

As shown in FIGS. 3-6, 15, and 16, one or more of the lights 402 are coupled to the top portion 226 of one or more of the charger mounts 204. The lights 402 coupled to the charger mount 204 are configured to illuminate the area around the charger 202 coupled with the charger mount 204 to help the operator see the surrounding area (e.g., when connecting or disconnecting a GSE therewith or therefrom). In some embodiments, two or more of the lights 402 are otherwise positioned about the charger mount 204 and/or charging cart 100. As shown in FIGS. 1-4, 7, and 16, one or more of the lights 402 are positioned along the roof 120 of the charging cart 100. The lights 402 positioned along the roof 120 may provide flashing lights or controlled to flash such that, when flashing, indicate that the charging cart 100 is deployed for charging purposes (e.g., to indicate that the charging cart 100 is or is not available to charge GSE, to make charging cart 100 visible to GSE and aircraft at the airport, etc.).

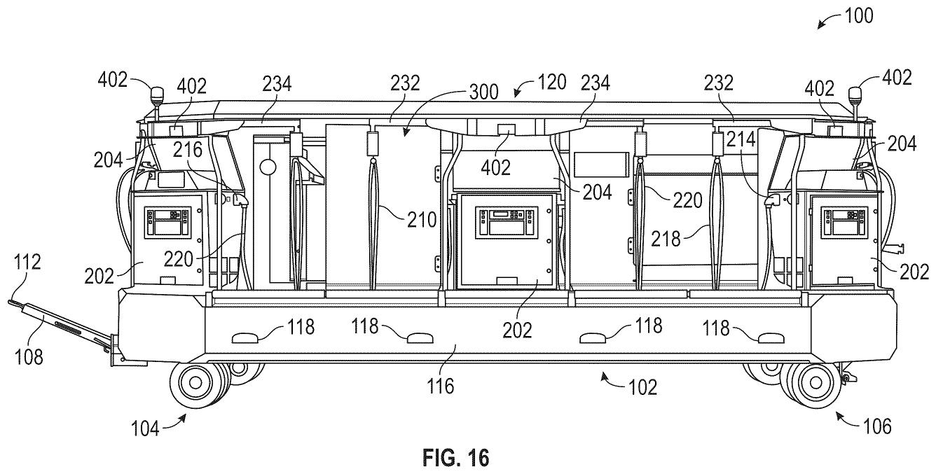

As shown in FIGS. 12 and 16, the I/O interfaces 400 include a charger mount interface, shown as user interface 404, and an emergency stop button, shown as emergency stop 406, positioned above each of the chargers 202. The user interface 404 may be used by an operator to provide commands to the components of the charger 202, the PDU 206, the on-board power system 300, other I/O interfaces 400, and/or still other components or systems of the charging cart 100. As shown in FIG. 12, the user interface 404 includes various buttons to provide the operator with control capabilities over a respective one of the chargers 202. The user interface 404 may include one or more additional buttons, knobs, touchscreens, switches, levers, joysticks, pedals, or handles. By way of example, the operator can press a button and/or otherwise interface with the user interface 404 to command the charger 202 to start or stop charging, turn one or more lights 402 (e.g., the lights 402 coupled to the respective charger mount 204) ON or OFF, start or stop operation of the on-board power system 300, etc. The emergency stop 406 may be used by the operator to manually override one or more operations of the charging system 200 (e.g., the charger 202, the PDU 206, etc.), the on-board power system 300, the I/O interfaces 400, the charging cart 100, and/or any one or more components included therein. By way of example, the emergency stop 406 facilities electrically isolating the respective charger 202 associated therewith from the rest of the components of the charging cart 100.

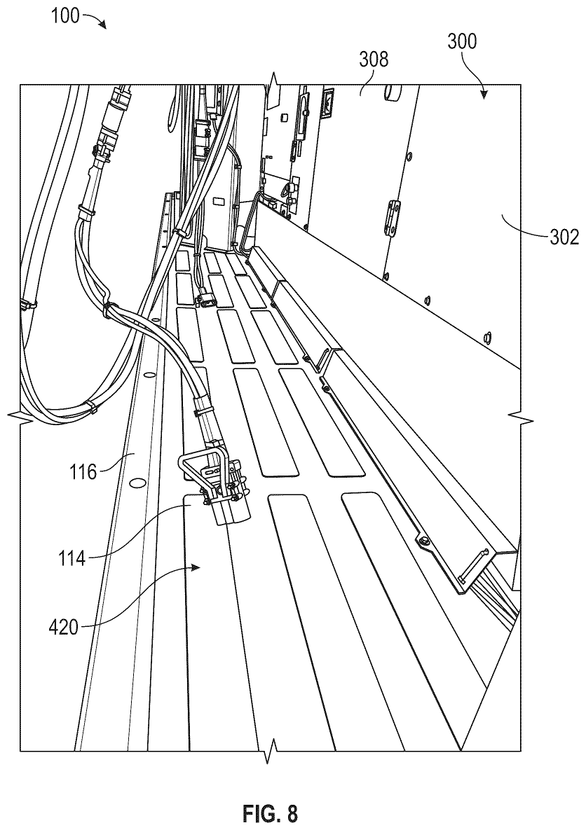

As shown in FIGS. 1-8, 11, 15, and 16, the on-board power system 300 is coupled to the charging cart 100 along the floor 114 thereof. In some embodiments, the on-board power system 300 is coupled to the charging cart 100 such that a weight of the on-board power system 300 is substantially equally distributed between the frame 102, the front tractive assembly 104, and the rear tractive assembly 106 (e.g., centered along a longitudinal length of the frame 102, centered along a lateral width of the frame 102, etc.). As shown in FIG. 8, the on-board power system 300 is positioned to provide a space, shown as alley 420, between the lateral sidewalls (e.g., a left sidewall and a right sidewall) of the housing 302 of the on-board power system 300 and an outer peripheral edge of the charging cart 100 (e.g., the guard 116 along the left peripheral edge of the frame 102 and floor 114, and the guard 116 along the right peripheral edge of the frame 102 and floor 114). The alley 420 provides a space for an operator to walk along the longitudinal length of the charging cart 100. By way of example, the operator may stand on the floor 114 of the alley 420 and interact (e.g., service, repair, clean, access, etc.) with the on-board power system 300 and the components thereof (e.g., the power generator 304, the user interface 306, the access panel 308, etc.). In other embodiments, the on-board power system 300 is otherwise positioned on the charging cart 100 and supported by the frame 102.

According to an exemplary embodiment shown in FIGS. 1-6, the charging cart 100 includes four sets of charger mounts 204 and chargers 202 coupled therewith where the charger mounts 204 and the chargers 202 are positioned along the floor 114 at the chamfered corners thereof. The charger mounts 204 and chargers 202 are arranged at an angle to align (e.g., match, correspond, etc.) with an angle created by the chamfered corners. In some embodiments, the charger mounts 204 and the chargers 202 are otherwise positioned and arranged along the floor 114 (e.g., along the peripheral edges of the floor 114, along the floor 114 around the housing 302 of the on-board power system 300). In embodiments where corners of the floor 114 are not chamfered, the charger mounts 204 and chargers 202 are arranged in the corners or otherwise positioned and arranged along the floor 114. With four chargers 202 having two electrical energy outputs each (e.g., the first battery cable 218 and the second battery cable 220), such a charging cart 100 is capable of supplying electrical energy to eight GSEs at the same time. By way of example, eight GSEs, of the same or of a different type, can be positioned about the area surrounding (e.g., about the periphery) of the charging cart 100, and each charger 202 can electrically couple to two of the eight GSEs to charge them.

According to an exemplary embodiment shown in FIGS. 14-20, the charging cart 100 includes six sets of charger mounts 204 and chargers 202 coupled therewith where the charger mounts 204 and the chargers 202 are (i) positioned along the floor 114 at the chamfered corners thereof and (ii) along the longitudinal (e.g., left and right) sides of the floor 114 within the alleys 420. The charger mounts 204 and the chargers 202 at the chamfered corners are arranged at an angle to align (e.g., match, correspond, etc.) with an angle created by the chamfered corners. In some embodiments, the charger mounts 204 and the chargers 202 are otherwise positioned and arranged along the floor 114. With six chargers 202 having two electrical energy outputs each (e.g., the first battery cable 218 and the second battery cable 220), such a charging cart 100 is capable of supplying electrical energy to twelve GSEs at the same time. By way of example, twelve GSEs, of the same or of a different type, can be positioned about the area surrounding (e.g., about the periphery) of the charging cart 100, and each charger 202 can electrically couple to two of the twelve GSEs to charge them.

In some embodiments, the charging cart 100 includes more or fewer than four or six sets of charger mounts 204 and chargers 202. By way of example, a charging cart 100 having a larger longitudinal length and/or lateral width may be able to fit more charger mounts 204 and chargers 202 to increase the number of GSEs capable of being charged thereby. The first arms 232, the second arms 234, and the reels 236 coupled thereto facilitate positioning the first battery cable 218 and the second battery cable 220 to electrically couple with the GSEs. The length of the first battery cable 218 and the second battery cable 220 vary based on the application and the size of the GSE positioned about the charging cart 100. By way of example, a longer first battery cable 218 or second battery cable 220 can be used to reach larger GSEs having connection ports (to which the first battery cable 218 or second battery cable 220 can electrically couple with) positioned farther away from the charging cart 100 when parked therearound.

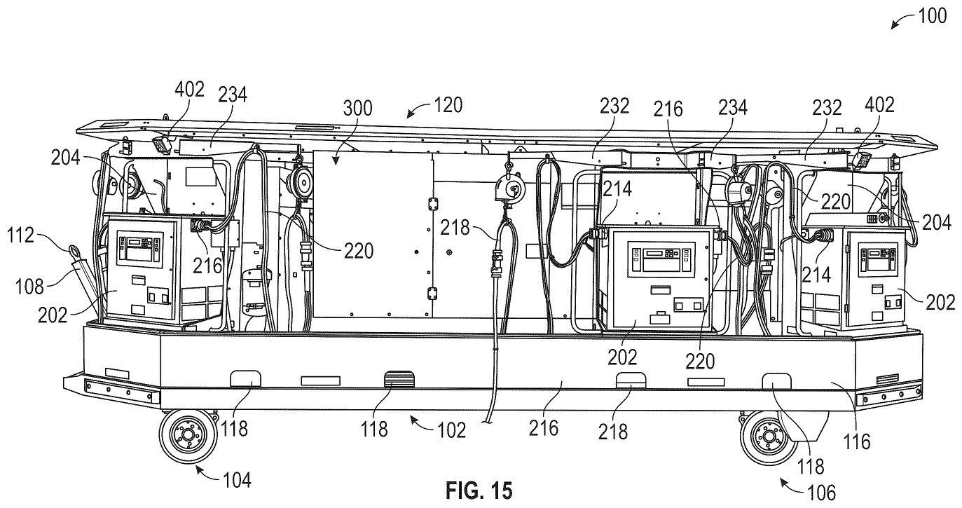

As shown in FIGS. 14-20, in embodiments where the charger mount 204 and the charger 202 are positioned along the longitudinal sides of the floor 114 within the alleys 420, the charger mounts 204 positioned along the longitudinal sides are coupled to a charger mount track assembly, shown as track assembly 430. The track assembly 430 facilitates longitudinal movement of the charger mount 204 (and the charger 202 coupled therewith) along the floor 114 within the alley 420. As shown in FIGS. 15 and 16, the track assembly 430 facilitates longitudinal movement of the charger mount 204 to selectively provide access to the on-board power system 300 and the components thereof (e.g., the power generator 304, the user interface 306, the access panels 308, etc.).

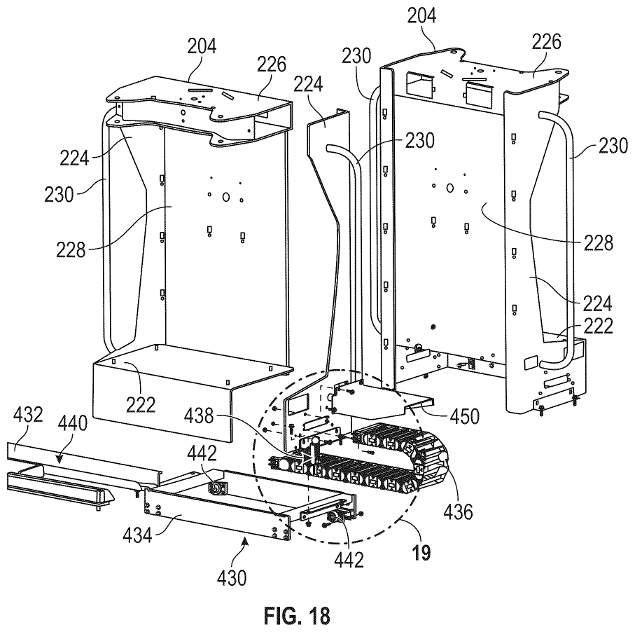

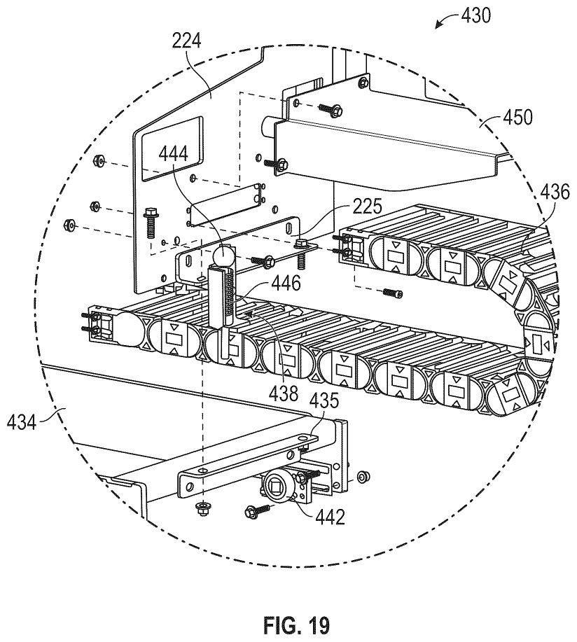

As shown in FIGS. 18-20, each track assembly 430 includes a guide, shown as guide member 432, a support, shown as support frame 434, a power track, shown as linkage 436, and a retainer, shown as retainer assembly 438. The guide member 432 includes two tracks (e.g., raceways, guides, grooves, flanges, walls, etc.), shown as tracks 440, that are laterally spaced apart from each other (e.g., by a width of the charger mount 204) and are each configured to receive a rolling element (e.g., the wheels 442). The guide members 432 are coupled to the floor 114 of the charging cart 100 within the alleys 420. As shown in FIGS. 18 and 19, the support frame 434 includes a plurality of frame members configured to support the charger mount 204 and the charger 202 coupled therewith. As shown in FIG. 19, a bracket 225 coupled with the sidewall 224 of the charger mount 204 is configured to interface with a bracket 435 of the support frame 434 to facilitate coupling the charger mount 204 with the support frame 434 using one or more fasteners. As shown in FIGS. 18 and 19, the support frame 434 includes a plurality of rolling elements, shown as wheels 442, rotatably coupled therewith. The wheels 442 are configured to support the support frame 434 and facilitate movement thereof. The wheels 442 are configured to be received within the tracks 440 to facilitate movement of the support frame 434 and the charger mount 204 coupled therewith along the length of the tracks 440.

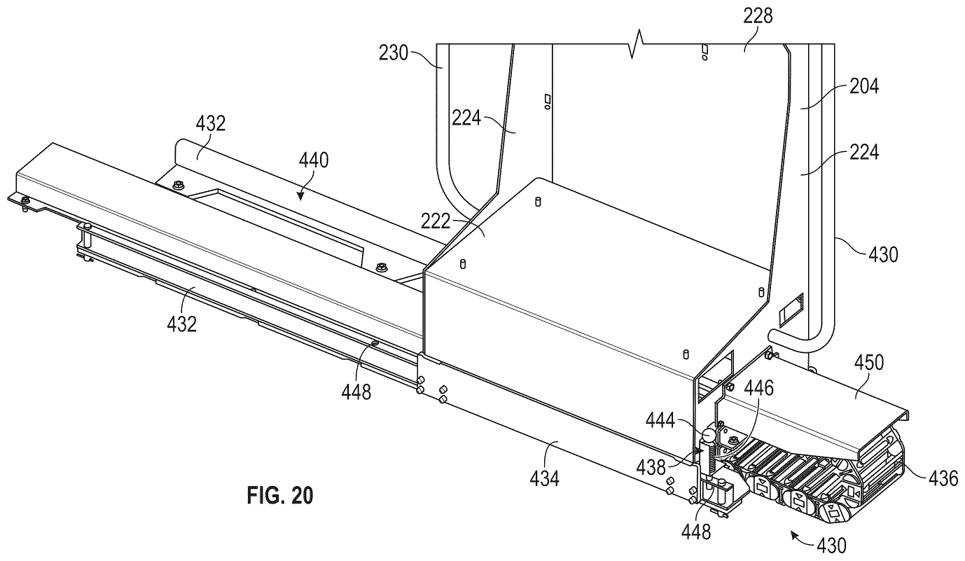

According to an exemplary embodiment, the retainer assembly 438 is configured to selectively permit longitudinal translation of the support frame 434 and the charger mount 204 along the guide member 432 within the alley 420 (e.g., translation of the charger mount 204 and the charger 202 relative to the charging cart 100). As shown in FIGS. 18-20, the retainer assembly 438 includes a stopper, shown as plunger 444, and a biasing element, shown as spring 446, engaged with the plunger 444 and configured to bias the plunger 444 in a vertically downward direction. In some embodiments, the retainer assembly 438 is otherwise arranged such that the spring 446 configured to bias the plunger 444 in a different direction (e.g., a vertically upward direction, a lateral direction, a longitudinal direction, etc.). The plunger 444 is actuatable (e.g., manually by an operator, automatically by an actuation mechanism, via a solenoid, etc.) from an engaged position to a released position by overcoming the force imparted on the plunger 444 by the spring 446. As shown in FIG. 20, the guide member 432 includes or defines an array of apertures, shown as openings 448, along the length thereof configured to receive the plunger 444 when in the engaged position. The retainer assembly 438 is configured to translate with the support frame 434 and the charger mount 204 such that the plunger 444 can engage with any one of the openings 448 to facilitate retaining (e.g., selectively fixing) the charger mount 204 at a desired location along the length of the guide member 432. By way of example, the plunger 444 may be transitioned to the released position to disengage a respective opening 448 and permit translation of the support frame 434 and the charger mount 204, then the plunger 444 may be transitioned to the engaged position to engage with a different opening 448 to retain the charger mount 204 at a desired location.

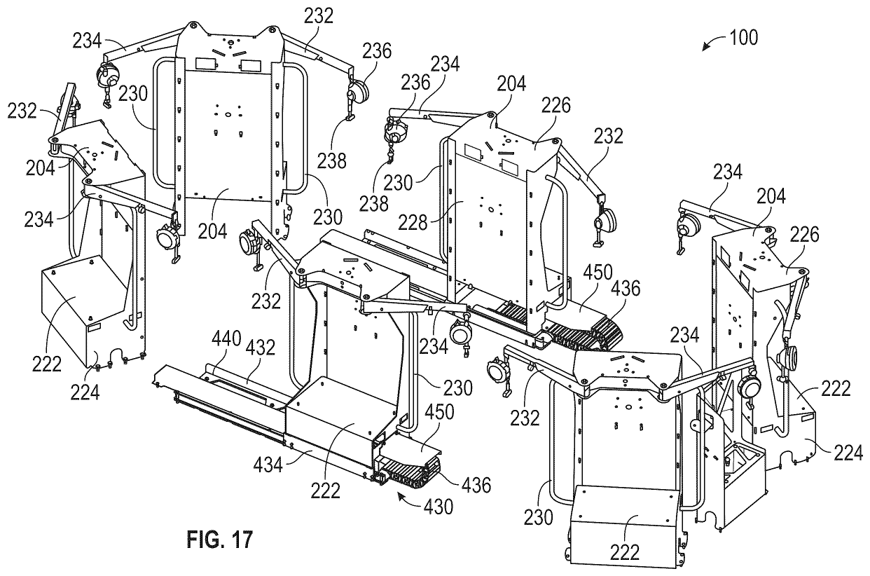

As shown in FIGS. 17-20, the linkage 436 includes a plurality of links pivotably coupled together such that the linkage 436 can bend and flex. The links are arranged in series (i.e., in a chain) and pivotable with respect to adjacent links. This pivoting causes linkage 436 to bend or fold in a predictable manner (e.g., in a predictable direction, at a predictable angle, etc.). By way of example, a first end of the linkage 436 may be fixedly coupled to a fixed component of the charging cart 100 (e.g., the guide member 432) and a second end of the linkage 436 may be fixedly coupled to the charger mount 204 (e.g., to one of the sidewalls 224). The linkage 436 may be configured to bend and roll along the floor 114 (e.g., a portion of the floor 114 in the alley 420, along the guide member 432, etc.) to accommodate for the translation of the support frame 434 and the charger mount 204. In such an example, the linkage 436 inhibits translation of the support frame 434 and the charger mount 204 beyond a length of the linkage 436. As shown in FIGS. 17-20, a plate or guard, shown as cover 450, is configured to couple to charger mount 204 (e.g., to one of the sidewalls 224 thereof) and extend over at least a portion of the linkage 436. The cover 450 is configured to provide protection and mitigate objects getting caught within the linkage 436.

As shown in FIGS. 1, 2, 5-7, and 15, the roof 120 is positioned to extend vertically above the chargers 202, the PDU 206, the on-board power system 300, and other components positioned along the floor 114 of the charging cart 100 to provide protection from weather (e.g., rain, snow, hail, etc.), falling objects (e.g., falling trees, pieces of equipment, etc.), and other factors that could cause damage. In some embodiments, the roof 120 is removably coupled to a top surface of the housing 302 of the on-board power system 300. In other embodiments, the roof 120 is coupled to columns extending from the frame 102 or the floor 114.

As shown in FIG. 21, the cart control system 500 includes the PDU 206 having a controller 502, a power inverter (e.g., a power inversion unit), shown as inverter 510, and a power converter (e.g., a power conversion unit), shown as converter 512; an external power supply (e.g., a power grid, a generator, an external battery, a mains power supply of an airport, etc.), shown as external power source 514; the on-board power system 300; one or more of the chargers 202; one or more GSEs (e.g., cars, trucks, buses, tractors, belt loaders, pushback tractors, tow-bar-less tractors, bag tugs, cargo loaders, powered dollys, de-icers, etc.), shown as GSEs 516; one or more of the I/O interfaces 400; and a remote system, shown as server 518, positioned remote or separate from the PDU 206 and the charging cart 100. In some embodiments, the controller 502 is separate from the PDU 206. As shown in FIG. 21, the PDU 206 and the server 518 communicate via one or more communications protocols (e.g., Bluetooth, Wi-Fi, cellular, radio, through the Internet, etc.) through a network 520. Similarly, the GSEs 516 and the server 518 communicate via one or more communications protocols (e.g., Bluetooth, Wi-Fi, cellular, radio, through the Internet, etc.) through the network 520.

The controller 502 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 21, the controller 502 includes a processor 504, a memory 506, and a communication interface 508. The processor 504 may include an ASIC, one or more FPGAs, a DSP, circuits containing one or more processing components, circuitry for supporting a microprocessor, a group of processing components, or other suitable electronic processing components. In some embodiments, the processor 504 is configured to execute computer code stored in the memory 506 to facilitate the activities described herein. The memory 506 may be any volatile or non-volatile or non-transitory computer-readable storage medium capable of storing data or computer code relating to the activities described herein. According to an exemplary embodiment, the memory 506 includes computer code modules (e.g., executable code, object code, source code, script code, machine code, etc.) configured for execution by the processor 504. In some embodiments, the controller 502 may represent a collection of processing devices. In such cases, the processor 504 represents the collective processors of the devices, and the memory 506 represents the collective storage devices of the devices.

The controller 502 may be configured to selectively engage, selectively disengage, control, or otherwise communicate with (e.g., communicably coupled with) components of the PDU 206, the external power source 514, the on-board power system 300, the chargers 202, the GSEs 516, and the I/O interfaces 400 (e.g., via the communication interface 508, a controller area network (“CAN”) bus, a wired connection via the first battery cable 218 and/or the second battery cable 220, etc.). By way of example, the controller 502 may send and receive signals (e.g., control signals) with the components of the PDU 206, the external power source 514, the on-board power system 300, the charger 202, and the I/O interfaces 400 (e.g., via the communication interface 508, via a wired or wireless connection, etc.). By way of another example, the controller 502 may be indirectly communicably coupled with the GSEs 516 via (i) direct communication between the controller 502 and the chargers 202 and (ii) a wired connection between the chargers 202 and the GSEs 516 via the first battery cable 218 and/or the second battery cable 220. By way of another example, the controller 502 may be indirectly communicably coupled with the GSEs 516 via the network 520. By way of still another example, the controller 502 may send and receive signals (e.g., control signals) with the GSEs 516 directly (e.g., via the communication interface 508, short range communications, etc.).

As shown in FIG. 21, the PDU 206 is electrically coupled with the external power source 514 (e.g., via the power inputs 245 of the PDU 206, via a power input port of the charging cart 100, etc.), the on-board power system 300, the chargers 202, the GSEs 516, and the I/O interfaces 400. The PDU 206 is configured to receive power (e.g., electric energy) from either the external power source 514 and/or the on-board power system 300 and allocate the power to the chargers 202, the I/O interfaces 400, and/or other electrical systems of the charging cart 100. As discussed in greater detail above, the PDU 206 includes the user interface 240 to toggle between receiving power from either the on-board power system 300 or the external power source 514. By way of example, when the user interface 240 is toggled to select the on-board power system 300 (indicative of a command to receive electrical energy from the on-board power system 300), the controller 502 is configured to transmit a signal to command the on-board power system 300 to provide the electrical energy generated thereby to the PDU 206. In such an example, if the on-board power system 300 is not generating electrical energy (e.g., in stand-by mode, powered off, etc.), the controller 502 is configured to, responsive to receiving an indication of an input to the user interface 240 or an input to the I/O interfaces 400, transmit a signal to command the on-board power system 300 to generate electrical energy. Similarly, responsive to receiving an indication of an input to the user interface 240 or an input to the I/O interfaces 400 (e.g., to stop providing power), the controller 502 is configured to transmit a signal to command the on-board power system 300 to stop generating electrical energy or otherwise stop providing the generated electrical energy to the PDU 206.

By way of another example, when the user interface 240 is toggled to select the external power source 514 (indicative of a command to receive electrical energy from the external power source 514), the controller 502 is configured to transmit a signal to command the external power source 514 to provide the electrical energy therefrom to the PDU 206. In some embodiments, when the external power source 514 is not electrically coupled with the charging cart 100 (e.g., when the charging cart 100 is deployed to charge the GSEs 516), responsive to selecting the external power source 514 with the user interface 240, the controller 502 is configured to transmit a signal to command the on-board power system 300 to stop generating electrical energy or otherwise stop providing the generated electrical energy to the PDU 206. Similarly, when the external power source 514 is electrically coupled with the charging cart 100, responsive to selecting the external power source 514 with the user interface 240, the controller 502 is configured to transmit a signal to command the on-board power system 300 to stop generating electrical energy or otherwise stop providing the generated electrical energy to the PDU 206, and begin accepting electrical energy from the external power source 514.

As shown in FIG. 21, the inverter 510 and the converter 512 are electrically coupled between (i) the on-board power system 300 and/or the external power source 514 and (ii) the chargers 202 and the I/O interfaces 400. The inverter 510 is configured to receive the electrical energy from the on-board power system 300 and/or the external power source 514 and convert the electrical energy before providing the electrical energy to the chargers 202 (e.g., to charge the GSE(s) 516 coupled thereto, etc.). By way of example, the on-board power system 300 and/or the external power source 514 may provide electrical energy with alternating current (“AC”) to the inverter 510 and the inverter 510 may convert the electrical energy to have direct current (“DC”) before providing the electrical energy to the charger 202. In other embodiments, the on-board power system 300 and/or the external power source 514 directly provides the electrical energy to the charger 202 (e.g., when the charger 202 and the battery of the GSE 516 are configured to receive the type of the electrical energy provided by the on-board power system 300 and/or the external power source 514). In some embodiments, each of the chargers 202 include the inverter 510 rather than the PDU 206. The converter 512 is configured to receive the electrical energy and condition the electrical energy to adjust a DC voltage level (e.g., step down the voltage). By way of example, the converter 512 may receive the electrical energy converted to have DC by the inverter 510 and adjust the DC voltage level to match the DC voltage level of the destination (e.g., to match a DC voltage level capable of being received by the charger 202 and/or the I/O interfaces 400). In some embodiments, the electrical energy supplied to the chargers 202 by the PDU 206 is not conditioned to a decreased DC voltage, and the electrical energy supplied to the I/O interfaces 400 by the PDU 206 is conditioned to a decreased DC voltage (e.g., because the I/O interfaces 400 are rated to receive the electrical energy at a lower voltage level than the chargers 202 and the batteries of the GSEs 516 to be charged thereby is rated to receive).

In some embodiments, the charger 202 is configured to detect and transmit (e.g., periodically) a signal indicative of (i) whether the charger 202 (e.g., any one of the chargers 202 of the charging cart 100) is currently in use (e.g., occupied, electrically coupled to and charging a GSE 516) and/or (ii) a status of the charging operation being performed thereby (e.g., a level of charge of the GSE 516 being charged, an estimated time until the GSE 516 reached a full charge, data relating to the performance of the charger 202, etc.) to the controller 502 (e.g., wirelessly via the communication interface 508, via a wired connection between the controller 502 and the charger 202). By way of example, the cart control system 500 may determine whether the charger 202 is currently in use based on a level of the power being drawn by the charging cart 100 and/or the chargers 202 thereof. In such embodiments, the controller 502 transmits a signal (e.g., through the network 520) to the server 518 associated with the data and signals received from the charger 202 (e.g., charger use, status, etc.). Similarly, in some embodiments, the on-board power system 300 is configured to detect and transmit (e.g., periodically) a signal indicative of (i) whether the on-board power system 300 is currently in use (e.g., generating electric energy) and/or (ii) a status of the electric energy generation operation being performed thereby (e.g., a level of fuel of the on-board power system 300, error messages, data relating to the performance of the on-board power system 300, etc.) to the controller 502 (e.g., wirelessly via the communication interface 508, via a wired connection between the controller 502 and the on-board power system 300). In such embodiments, the controller 502 transmits a signal (e.g., through the network 520) to the server 518 associated with the data and signals received from the on-board power system 300 (e.g., generator use, status, etc.).

The server 518 may provide the data to a user (e.g., an accredited user with access to the server 518 and the data stored thereon such as a fleet manager, an owner/operator, etc.) and may display the data. The user may make operational decisions based on the data received from the charger 202 and the on-board power system 300. By way of example, based on an indication that a charger 202 is not in use (e.g., the first battery cable 218 and/or the second battery cable 220 is not electrically coupled to a GSE 516), the user may instruct a GSE 516 (e.g., a GSE 516 with a low charge) to navigate to the particular charger 202 that is not in use to be charged thereby. By way of another example, based on an indication of an error associated with the operation of the charger 202 and/or the on-board power system 300, the server 518 may transmit (e.g., automatically or responsive to an input from the user) a signal to the particular charger 202 and/or on-board power system 300 to recalibrate or shut off. In such an example, the user may instruct a technician to service or replace the particular charger 202 and/or on-board power system 300. By way of still another example, based on an indication that a charger 202 is not in use, the server 518 may transmit (e.g., automatically or responsive to an input from the user) a signal directly to one or more of the GSEs 516 through the network 520 (e.g., to instruct the one or more GSEs 516 to navigate to charger 202 that is not in use).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled,” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the charging cart 100 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A mobile charging unit comprising:
a chassis including a support surface;
a plurality of tractive assemblies coupled to the chassis, the plurality of tractive assemblies configured to engage a ground surface; and
a charging system including:
at least one of (a) an on-board power system positioned along the support surface and configured to provide electrical energy or (b) a power input configured to receive power from an external power source;
a plurality of chargers configured to electrically couple with at least one ground service equipment (GSE) to provide electrical energy thereto; and
a power distribution unit electrically coupled with the plurality of chargers and the at least one of the on-board power system and the power input, the power distribution unit configured to provide electrical energy at least one of (i) provided by the on-board power system to the plurality of chargers or (ii) provided by the external power source to the plurality of chargers.

2. The mobile charging unit of claim 1, wherein the charging system includes the on-board power supply and the power input, and wherein the on-board power system includes at least one of a generator or a battery bank.

3. The mobile charging unit of claim 1, wherein the charging system includes a plurality of charger mounts coupled to the support surface of the chassis and positioned around the generator, the plurality of charger mounts supporting the plurality of chargers.

4. The mobile charging unit of claim 3, wherein the support surface has chamfered corners, wherein the plurality of charger mounts include four charger mounts, and wherein one of the four charger mounts is positioned at each of the chamfered corners.

5. The mobile charging unit of claim 4, wherein the plurality of charger mounts include a fifth charger mount, further comprising a track assembly coupling the fifth charger mount to the support surface between two of the chamfered corners, the track assembly configured to facilitate selectively repositioning the fifth charger mount and a respective charger of the plurality of chargers supported thereby relative to the support surface, wherein repositioning the respective charger mount and the respective charger supported thereby facilitates accessing the generator.

6. The mobile charging unit of claim 5, wherein the track assembly includes:
a guide coupled to the support surface, the guide defining a track and a plurality of apertures along a length thereof;
a support frame supporting the fifth charger mount, the support frame including one or more rollers configured to engage with the track; and
a retainer configured to:
translate with the support frame and the fifth charger mount; and
selectively engage with a respective aperture of the plurality of apertures to facilitate selectively retaining the fifth charger mount at a desired location along the length of the guide.

7. The mobile charging unit of claim 5, further comprising a housing supported by the chassis, wherein the generator is disposed within the housing, wherein the housing includes an access panel, wherein the generator is accessible through the access panel when the fifth charger mount and the respective charger are in a first position, and wherein the generator is not accessible through the access panel when the fifth charger mount and the respective charger are in a second position.

8. The mobile charging unit of claim 4, wherein the support surface has a substantially rectangular shape having a first end, an opposing second end, and opposing sides, wherein the power distribution unit is positioned proximate the first end and between a first set of the four charger mounts, further comprising a storage compartment positioned proximate the opposing second end and between a second set of the four charger mounts.

9. The mobile charging unit of claim 3, further comprising:
an arm having a first end pivotably coupled to a first interface of a respective one of the plurality of charger mounts; and
a reel coupled to an opposing second end of the arm, the reel includes a coupler configured to selectively couple with a charging cable of a respective one of the plurality of chargers supported by the respective one of the plurality of charger mounts such that repositioning the arm relative to the respective one of the plurality of charger mounts facilitates repositioning the charging cable therewith.

10. The mobile charging unit of claim 9, wherein the arm is a first arm, the reel is a first reel, the coupler is a first coupler, and the charging cable is a first charging cable, further comprising:
a second arm having a first end pivotably coupled to a second interface of the respective one of the plurality of charger mounts; and
a second reel coupled to an opposing second end of the second arm, the second reel includes a second coupler configured to selectively couple with a second charging cable of the respective one of the plurality of chargers supported by the respective one of the plurality of charger mounts such that repositioning the second arm relative to the respective one of the plurality of charger mounts facilitates repositioning the second charging cable therewith.

11. The mobile charging unit of claim 10, wherein the first arm and the second arm have differing lengths.

12. The mobile charging unit of claim 3, further comprising a guard positioned along a periphery of the support surface and extending upward therefrom.

13. The mobile charging unit of claim 12, wherein the guard defines a plurality of openings positioned along a lower edge thereof, and wherein the plurality of openings at least one of (i) permit fluid collected on the support surface to pass or (ii) provide a space for a user to step onto the support surface.

14. The mobile charging unit of claim 12, wherein each of the plurality of charger mounts includes a pedestal that supports a respective one of the plurality of chargers and elevates the respective one of the plurality of chargers relative to the support surface such that a bottom of the respective one of the plurality of chargers substantially aligns with a top edge of the guard.

15. The mobile charging unit of claim 1, further comprising a roof extending above the generator and the charging system, wherein the roof includes a plurality of panels.

16. The mobile charging unit of claim 1, further comprising a plurality of lights electrically coupled with the power distribution unit, the plurality of lights including (i) first lights configured to illuminate an area surrounding the mobile charging unit and (ii) second lights configured to provide an indication to a surrounding environment.

17. The mobile charging unit of claim 1, further comprising a control system configured to:
receive a status associated with a charging operation of the plurality of chargers;
determine whether the plurality of chargers are electrically coupled to a respective GSE based on the status of the plurality of chargers; and
transmit a signal indicting whether one or more of the plurality of chargers are available for use.

18. A mobile charging unit comprising:
a chassis including a support surface;
a plurality of tractive assemblies coupled to the chassis, the plurality of tractive assemblies configured to engage a ground surface;
a charging system including:
a generator positioned along the support surface and configured to generate electrical energy;
a plurality of chargers configured to electrically couple with at least one ground service equipment (GSE) to provide electrical energy thereto;
a plurality of charger mounts configured to couple to the support surface of the chassis and support the plurality of chargers;
a power input configured to receive power from an external power source; and
a power distribution unit electrically coupled with the plurality of chargers, the generator, and the power input, the power distribution unit configured to provide electrical energy at least one of (i) generated by the generator to the plurality of chargers or (ii) provided by the external power source to the plurality of chargers; and
a control system configured to:
control operation of at least one of the generator, the plurality of chargers, or the power distribution unit;
determine a respective charger of the plurality of chargers is free based on a determination that the GSE is not electrically coupled with the respective charger; and
transmit a signal indicating that the respective charger is available for use.

19. A mobile charging unit comprising:
a chassis having a first end, an opposing second end, a first side, an opposing second side, and a support surface having a substantially rectangular shape with chamfered corners;
a plurality of tractive assemblies coupled to the chassis, the plurality of tractive assemblies configured to engage a ground surface;
a tow bar pivotably coupled to the first end of the chassis, the tow bar configured to couple to a vehicle to facilitate repositioning the mobile charging unit;
a generator system including a housing positioned along the support surface and a generator positioned within the housing, the housing having an access panel positioned at the first side of the chassis;
a power input configured to receive power from an external power source;
a plurality of charger mounts coupled to the support surface, the plurality of charger mounts including:
four charger mounts, one of the four charger mounts positioned at each of the chamfered corners; and
a fifth charger mount positioned at the first side of the chassis;
a plurality of chargers configured to electrically couple with ground service equipment (GSE) to provide electrical energy thereto, each of the plurality of chargers supported by one of the plurality of charger mounts;
a power distribution unit electrically coupled with the plurality of chargers, the generator, and the power input, the power distribution unit configured to provide electrical energy at least one of (i) generated by the generator to the plurality of chargers or (ii) provided by the external power source to the plurality of chargers; and
a track assembly coupling the fifth charger mount to the support surface, the track assembly configured to facilitate selectively repositioning the fifth charger mount and a respective charger of the plurality of chargers supported thereby relative to the support surface, wherein repositioning the respective charger mount and the respective charger supported thereby facilitates accessing the access panel.

20. The mobile charging unit of claim 19, further comprising a guard positioned along a periphery of the support surface and extending upward therefrom, wherein:
the guard defines a plurality of openings positioned along a lower edge thereof, the plurality of openings at least one of (i) permitting fluid collected on the support surface to pass therethrough or (ii) providing a space for a user to step onto the support surface;
the power distribution unit is positioned proximate the first end and between a first set of the four charger mounts, further comprising a storage compartment positioned proximate the opposing second end and between a second set of the four charger mounts; and
each of the plurality of charger mounts includes:
a pedestal that supports a respective one of the plurality of chargers and elevates the respective one of the plurality of chargers relative to the support surface such that a bottom of the respective one of the plurality of chargers substantially aligns with a top edge of the guard;
a first arm having a first arm end pivotably coupled to a first interface thereof;
a first reel coupled to an opposing second arm end of the first arm, the first reel including a first coupler configured to selectively couple with a first charging cable of the respective one of the plurality of chargers such that repositioning the first arm relative to the respective one of the plurality of charger mounts facilitates repositioning the first charging cable therewith;
a second arm having a first arm end pivotably coupled to a second interface thereof; and
a second reel coupled to an opposing second arm end of the second arm, the second reel including a second coupler configured to selectively couple with a second charging cable of the respective one of the plurality of chargers such that repositioning the second arm relative to the respective one of the plurality of charger mounts facilitates repositioning the second charging cable therewith.
